(19) United States
(12) Patent Application Publication
(10) Pub. No.: US 2002/0049754 A1
(43) Pub. Date: Apr. 25, 2002

(54) Expenditure management system, method and recording media

(75) Inventor: Akinori Ohsako, Inzai-shi (JP)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 09/929,797

(22) Filed: Aug. 14, 2001

(30) Foreign Application Priority Data
Aug. 18, 2000 (JP) 2000-248308

(51) Int. Cl. G06F 7/00

(52) U.S. Cl. 707/3; 707/104.1

(57) ABSTRACT

Provides expenditure management methods and systems for performing the handling of consumption tax and for performing various kinds of management by creating master data for appropriation and write-off of expenditures and master data for transfer within an organization. One system for managing expenditure for automatic transfer service of rates includes: a detail data input section; a pre-journalizing details database for storing this detail data; a master database for storing master data; a data collation and journalizing section for collating the detail data with the master data and creating journal data; and an appropriation database and transfer journal database for storing the journal data. It creates journal data according to contents of processing for the expenditure management, while the master database stores multiple kinds of master data depending on the multiple kinds of journal data created by the data collation and journalizing section.

### FIELD OF THE INVENTION

The present invention relates to expenditure management. More particularly it relates to managing accounts and accounting in response to automatic transfer service of rates.

### BACKGROUND

Nowadays, automatic transfer services are widely used, wherein public utility rates and costs of goods that are regularly purchased (e.g., subscribed publications) are automatically paid from an account at the financial institution such as a bank. In this kind of transfer service, detail data about rates is created at a correspondent (payee of rates), such as a public agency, and provided to a paying entity, however, these detail amounts are generally payments only. On the contrary, since five percent of consumption tax is imposed on general consumption in Japan, the amount of consumption tax has been calculated by multiplying payments by a value of 5/105, in order to comprehend and obtain the consumption tax from the detail data.

Besides, in a relatively complicated organization such as an enterprise, it is common to perform the accounting procedure and financial management, including journalizing within an organization, using an accounting system. In this case, master data is created to manage the handling of expenditures in an organization, then collating the detail data from the correspondent with the master data, thereafter the journal data that is used in the accounting system is created or the accounting procedure is performed.

FIG. 7 is a diagram showing a configuration example of a conventional accounting system that manages an automatic transfer service. FIG. 7 shows an example of performing the automatic transfer for telephone rates. Depending on the use of telephones in an organization 100, utilization data occurs at a telephone company 200. Concurrently, master data is created at an organization 100 depending on the same use and stored in a master database 110. Then, the telephone company 200 creates detail phone call data 201 on the basis of utilization data and provides it to the organization 100. The organization 100 receives the detail phone call data 201 and collates the detail phone call data 201 with master data 101 stored in the master database 110 at the data collation section 120 using a telephone number key as a collation key.

Journal data for appropriation and write-off (or transfer) of expenditures 102 obtained from this collation is stored in the cash book database 130 and the general ledger database 140. After telephone rates are checked off from an account at the financial institution 300 such as a bank, recorded data of the account balance of the organization 100 is compared with data of the cash book database 130 and the general ledger database 140 at the financial affairs/fund management section 150 in order to check corrigenda of the automatic debt transfer.

When managing the automatic transfer service by such a system, there is a method wherein the master data is created in a lump for appropriation and write-off of expenditures and there is a method wherein master data is created for every unit of service use or purchase of goods (hereinafter referred to herein as unit of use) in view of transfers between departments of an organization. In a large-scale organization, it is common to create master data for every unit of use for convenience of journalizing within the organization. In the example shown in FIG. 7, master data 101 is created for every phone call and collated with the detail phone call data 201.

### PROBLEMS TO BE SOLVED BY THE INVENTION

As mentioned above, presently, comprehending and obtaining a consumption tax from detail data of rates that are created in the conventional automatic transfer service, an amount of consumption tax is calculated by multiplying payments by a value of 5%.

However, there might be a problem when calculating an amount of consumption tax by a uniform calculation like this. For example, when applying the automatic transfer service to payments of telephone rates, 5% of consumption tax is imposed on domestic phone calls, thus a consumption tax is able to be calculated by the above calculation. However, as for an international call, no consumption tax is imposed, thus the above calculation can not be applied to the payments of the detail data. Likewise, the amount of consumption tax that is calculated by the above uniform calculation on the basis of the detail data including transactions between nations, does not match the amount of consumption tax to be actually imposed on payments.

Conventionally, in order to manage the automatic transfer service by an accounting system based on a computer in an organization such as an enterprise, it is common to create master data for every unit of use to manage the handling of expenditures, and to collate the master data with detail data from correspondents.

In a large-scale organization, it is often the case that rates are paid for every department rather than being paid in a lump, thus the rates paid by the automatic transfer service need to be separated for every department. Therefore, master data needs to be created for every unit of use in order to transfer between the departments and specify a department which should pay the rate.

However, when creating master data for every unit of use and managing the automatic transfer service, an account transfer at a financial institution is performed for every unit of use. For this reason, recorded data of an account balance involved in the account transfer becomes enormous, which makes an accounting procedure complicated.

### SUMMARY OF THE INVENTION

It is therefore an aspect of the present invention to provide an expenditure management system for performing the handling of consumption tax.

It is another aspect of the invention to provide an expenditure management system for performing various kinds of management by creating master data for appropriation and write-off of expenditures and master data for transfer within an organization.

### BRIEF DESCRIPTION OF THE DRAWINGS

These and other aspects, features, and advantages of the present invention will become apparent upon further consideration of the following detailed description of the invention when read in conjunction with the drawing figures, in which:

FIG. 1 is a diagram illustrating an expenditure management system according to an example embodiment of the present invention;

FIG. 2 is a diagram showing a configuration example of data stored at the pre-journalizing details database with respect to telephone rates paid to a telephone company according to the embodiment of the present invention;

FIG. 3 is a diagram showing a configuration example of an input format for registering master data with the master database according to the embodiment of the present invention;

FIG. 4 is a diagram showing an operation for creating appropriation journal data by a data collation and journalizing section according to the embodiment of the present invention;

FIG. 5 is a diagram showing an operation for creating transfer journal data by the data collation and journalizing section according to the embodiment of the present invention;

FIG. 6 is a diagram showing appropriation journal data and transfer journal data generated from detail data converted to a unified format and master data according to the embodiment of the present invention;

FIG. 7 is a diagram showing a configuration example of a conventional accounting system that manages the automatic transfer service.

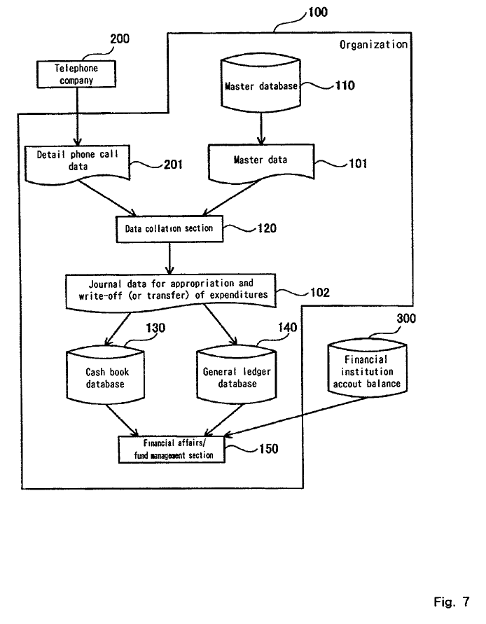

### DESCRIPTION OF THE SYMBOLS

10: Detail data input section

20: Data format conversion section

30: Pre-journalizing details database

40: Master database

50: Data collation and journalizing section

60: Appropriation database

70: Transfer journal database

### DETAILED DESCRIPTION OF THE INVENTION

The present invention, provides an expenditure management system that manages expenditure for an automatic transfer service of rates. An example system includes: a detail data input section for inputting detail data about this rates; a pre-journalizing details database for storing this detail data input at the detail data input section; a master database for storing master data used for journalizing on the basis of collation with the detail data; a data collation and journalizing section for collating the detail data stored in the pre-journalizing details database with the master data stored in the master database and creating journal data; and a journal database for storing the journal data created at the data collation and journalizing section. The data collation and journalizing section creates multiple kinds of journal data according to the contents of processing for the expenditure management, while the master database stores multiple kinds of master data depending on the multiple kinds of journal data created by the data collation and journalizing section.

The processing in the expenditure management involves, for example, processing for performing appropriation and write-off of expenditures in a lump as an overall organization, and processing for transfer between departments within the organization, when a given organization uses the automatic transfer service.

The expenditure management system often further includes a data format conversion section that converts the detail data input at the detail data input section into a unified data format, wherein the pre-journalizing details database stores the detail data converted at the data format conversion section. This allows handling the detail data created at the correspondents (i.e., payees of rates) uniformly in a common data format, even if the data format of those detail data is unique to each correspondent.

The unified data format that is converted at the data format conversion section comprises at least a transfer key, an amount for each transfer key, and identification data showing a kind of data that was classified according to journalizing by the data collation and journalizing section. Moreover, the master database stores a first master data that manages a total amount of main body that does not include consumption tax within the rates in the detail data, which is used for appropriation and write-off of expenditures as the processing in the expenditure management; and a second master data that manages an amount for each transfer key in the detail data, which is used for transfer as the processing in the expenditure management.

The invention, also provides an expenditure management system which generally includes detail data storing means for storing detail data about rates; and journalizing means for journalizing the detail data, wherein the detail data storing means classifies the detail data into data for each transfer key, data about a total amount of main body that does not include consumption tax, and data about total consumption tax and storing, wherein the journalizing means collates master data prepared for collation with the detail data according to the contents of journalizing with data necessary for the journalizing within the detail data and performs journalizing.

More specifically, the detail data storing means further classifies data for each transfer key in the detail data into an amount subject to consumption tax and a nontaxable amount.

Further, the journalizing means collates data about the total amount of main body stored in the detail data storing means and data about the consumption tax with master data corresponding to data about the total amount of main body, thereby journalizing for appropriation and write-off of expenditures. Moreover, the journalizing means collates data for each transfer key stored in the detail data storing means with master data corresponding to data for this transfer key, thereby journalizing for transfer.

In a further embodiment of the present invention, there is also provided a method for managing expenditure for an automatic transfer service of rates. The method generally includes the steps of: acquiring detail data about the rates; creating a plurality of master data according to contents of journalizing, wherein the master data is used for journalizing on the basis of collation with the detail data; and collating the detail data with the master data and creating multiple kinds of journal data according to contents of processing in the expenditure management.

In some embodiments, the method further comprises after the step of acquiring detail data, the step of converting the acquired detail data into a unified data format.

In some cases, the method further includes after the step of acquiring detail data, the step of classifying the acquired detail data into data for each transfer key, data about a total amount of main body that does not include consumption tax, and data about total consumption tax.

More specifically, the step of classifying the detail data further comprises the step of multiplying a total amount of main body subject to consumption tax within data for each transfer key in the detail data by a value corresponding to a consumption tax rate to calculate an amount of consumption tax for the data about total consumption tax.

The step of creating master data often further comprises the steps of: creating a first master data that manages a total amount of main body that does not include consumption tax within the rates in the detail data; and creating a second master data that manages an amount for each transfer key in the detail data. On the other hand, the step of creating journal data comprises the steps of: collating the detail data with the first master data to create journal data for appropriation and write-off of expenditures; and collating the detail data with the second master data to create journal data for transfer.

In a further embodiments of the present invention, there is provided a recording medium storing a computer program that causes the computer to execute the processing. In many of these embodiments the processing includes: processing for acquiring detail data about rates; processing for acquiring a plurality of master data prepared according to contents of journalizing, wherein the master data is used for journalizing on the basis of collation with the detail data; and processing for collating the detail data with the master data and creating multiple kinds of journal data according to contents of processing in the expenditure management.

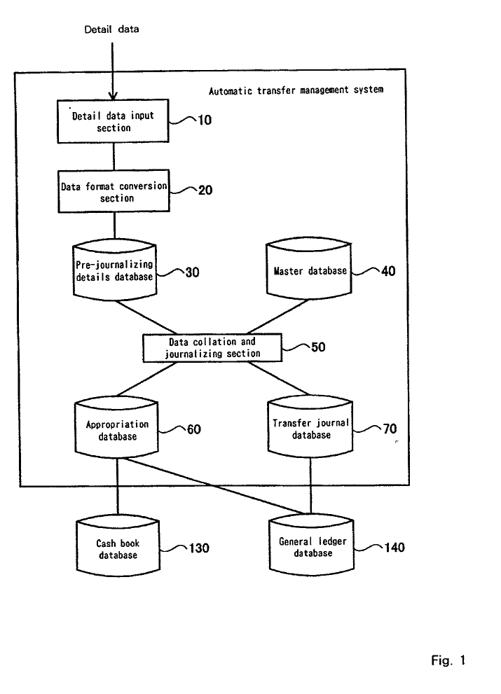

Now the present invention will be described on the basis of advantageous embodiments shown in the accompanying drawings. In particular, FIG. 1 is a diagram illustrating an example of an expenditure management system according to the embodiment of the present invention.

In FIG. 1, a symbol 10 is a detail data input section, which inputs detail data that is issued from a correspondent. A symbol 20 is a data format conversion section, which converts the detail data received at the detail data input section 10 into a common data format. A symbol 30 is a pre-journalizing details database, which stores the detail data converted by the data format conversion section 20 with adding an ID. A symbol 40 is a master database, which stores master data for managing the handling of expenditures in an organization that uses an automatic transfer service. A symbol 50 is a data collation and journalizing section, which collates the detail data stored in the pre-journalizing details database 30 with the master data stored in the master database 40 and then journalizing data. A symbol 60 is an appropriation database, which stores data collated at the collation and journalizing section 50 as data for appropriation and write-off of expenditures. A symbol 70 is a transfer journal database, which stores data collated at the collation and journalizing section 50 as data for transfer between departments in an organization.

In the above configuration, the detail data input section 10 inputs detail data of public utility rates that occur for use of telephone, electricity, water and gas, and detail data of rates to be paid by account transfer due to the automatic transfer service at a financial institution. The detail data is stored in various recording media such as an MO (magnetic optical disk) and CD-ROM or is input to the detail data input section 10 via communication network. Therefore, the detail data input section 10 is implemented by a drive equipment for various kinds of recording media or an interface for communication.

The data format conversion section 20 is implemented by, for example, a program-controlled CPU, which converts the detail data received at the detail data input section 10 into a given data format. Detail data usually has a different data format depending on public agencies and enterprises which issue the detail data. Hence, the data format conversion section 20 converts these data into a unified data format.

A unified data format includes, as a data item, at least a transfer key for collation with master data, an amount for each transfer key, and a data ID showing a kind of data. A transfer key is, for example, a telephone number in the case of the detail data of telephone rates. This allows creating the detail data of rates for every telephone number. A data ID is identification data added to the data according to the contents of the classification, when the rates described in the detail data need to be classified in journalizing, as described below. For example, when managing the expenditure for the automatic transfer service, it is an important factor for calculation whether consumption tax is imposed on the amount of transfer key. Therefore, data ID can be set in order to differentiate the taxable amount and nontaxable amount. Off course, the data may be classified by any other classification depending on the contents of journalizing to set a data ID showing the classification. As a data item in the data format that is unified at the data format conversion section 20, there are, for example, a ledger code specifying a ledger and a correspondent code specifying a correspondent, depending on the utilization form of data.

The pre-journalizing details database 30 is implemented by a storage device such as a magnetic disk drive and a semiconductor memory, which stores the detail data whose data format is unified at the data format conversion section 20. As for the detail data, processed data, such as a total amount, an amount of consumption tax and a discount rate, is associated with and stored.

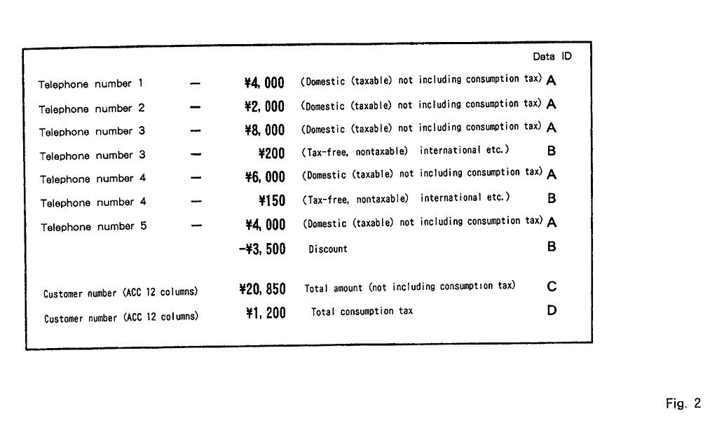

FIG. 2 is a diagram showing a configuration example of data stored at the pre-journalizing details database 30 with respect to telephone rates paid to a telephone company. As is shown in the figure, the pre-journalizing details database 30 stores pre-journalizing detail data for each correspondent, while a correspondent code specifying a correspondent is omitted in the shown example.

Referring to FIG. 2, an amount of main body, 210 attached information, and a data ID 220 are stated for each telephone number serving as a transfer key. As for an amount of main body, a taxable amount refers to an amount of only main body that does not include consumption tax within the rates that are actually paid, while a nontaxable amount refers to an amount to be paid actually. As an attached information, it is stated whether the imposition of consumption tax is available or not. As a data ID, “A” is assigned to data that is taxable, while “B” is assigned to data that is nontaxable. In addition, if both taxable and nontaxable amounts occur for a given transfer key with the same name (see “telephone number 3” and “telephone number 4”), they are stated as a different item respectively.

Moreover, items such as a discount rate, a total amount of main body of rates, and a total consumption tax are stated. The total consumption tax is an amount of consumption tax that is imposed on the total amount of main body of the taxable rates. As for a data ID, a discount rate that is not subject to consumption tax is assigned “B”, which is the same as the case of nontaxable data, while the total amount of main body is assigned “C”, and the total consumption tax is assigned “D”.

Therefore, the following relation is established among an amount of each transfer key, the total amount of main body and the total consumption tax.

C=(total of A)+(total of B)

D=(total of A)×(5/100)

It is noted that a discount rate accompanies a minus sign.

As mentioned above, classifying the rates that have occurred into taxable rates and nontaxable rates and representing the total amount of rates by the total amount of main body and the total consumption tax, it is easy to understand which rate is subject to consumption tax, thus a correct handling becomes possible.

The master database 40 is implemented by a storage device such as a magnetic disk drive and a semiconductor memory, which stores master data including various kinds of information necessary for paying the expenditure by automatic debt transfer. A configuration of master data may be set arbitrarily according to the utilization form of the master data in a system, however, for the sake of collation with detail data stored in the pre-journalizing details database 30, it includes at least a collation key corresponding to a transfer key of the detail data, data ID, and in addition, code data if the detail data includes a ledger code or a correspondent code. Furthermore, an account title code necessary for later journalizing and an imposed department code specifying an imposed department that actually pays rates may be included.

In addition, according to the present invention, journal data for appropriation and write-off of expenditures and journal data for transfer in an organization are created from detail data stored in the pre-journalizing details database 30. Therefore, in data collation described below, two kinds of master data are created for the sake of collation according to these journalizing. Hence, master data includes a master type for identifying which collation the master data is used for.

The registration of master data with the master database 40 is performed by, for example, displaying an input format of the created Web pages using HTML to an input terminal and inputting information necessary for this input format.

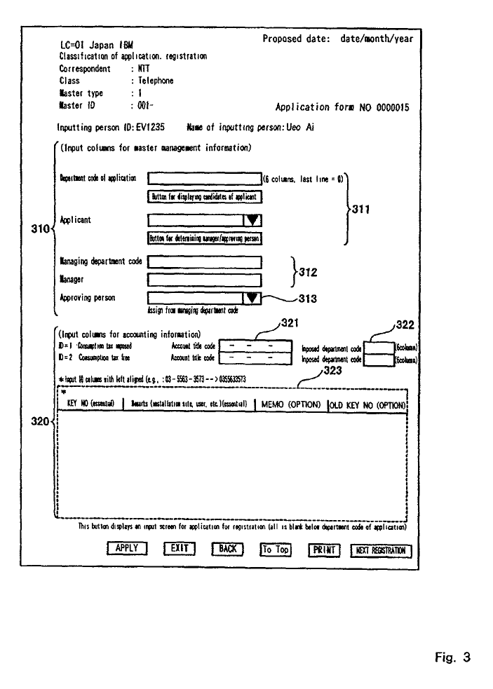

FIG. 3 is a diagram showing a configuration example of such an input format (i.e., input screen). Referring to FIG. 3, there are specified a ledger code (shown as LC in the drawing), a correspondent code, identification data of master type, etc. As an input column 310 of management information of master data, there are provided an input column 311 for information specifying an applicant, an input column 312 for information specifying a manager, and an input column 313 for information specifying an approving person. As an input column 320 of accounting information, there are provided an input column 321 for an account title code that specifies an account title in detail data after journalizing, an input column 322 for an imposed department code, and an input column 323 for a collation key. As for the input column 321 for an account title code and the input column 322 for an imposed department code, two columns are provided respectively, that is, one for taxable and the other for nontaxable, which include information corresponding to data IDs in detail data of the pre-journalizing details database 30.

The data collation and journalizing section 50 is implemented by, for example, a program-controlled CPU, which collates detail data stored in the pre-journalizing details database 30 with master data stored in the master database 40 and journalizing the detail data.

As mentioned above, the journal data includes appropriation journal data for appropriation and write-off of expenditures and transfer journal data for transfer in an organization. Therefore, the data collation and journalizing section 50 creates the appropriation journal data and the transfer journal data in principle, however, it may create either one of those journal data depending on an operative condition of a system, a configuration of the detail data, a form of payment, etc.

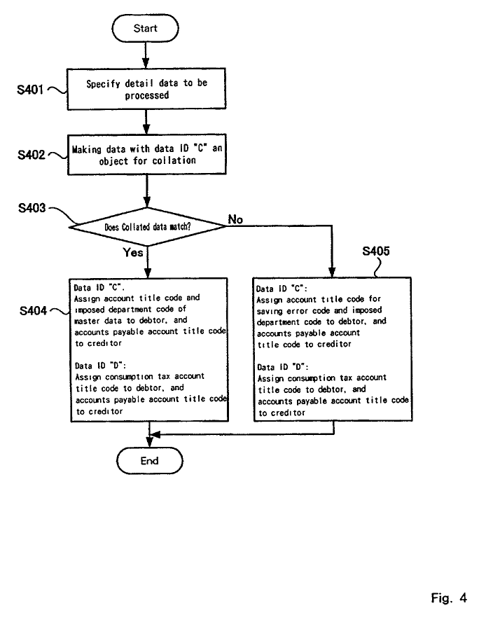

FIG. 4 is a diagram showing an example of an operation for creating appropriation journal data by the data collation and journalizing section 50. Referring to FIG. 4, first, detail data that is to be processed is specified using a correspondent code or the like (step 401). Then, specifying a kind of detail data necessary for creating the appropriation journal data by using a data ID, and making it an object for collation (step 402). In this operation, journal data is created that is used for appropriation or write-off of expenditures to be paid to a correspondent by an organization, thus the object of collation is a total amount of expenditures that have occurred, which correspond to data with data ID “C” in the example shown in FIG. 2. On the other hand, in master data, an object of collation is master data of a master type that is to be used for creating the appropriation journal data.

Then, a ledger code, a correspondent code, a transfer key (collation key), and a data ID are collated between the detail data and the master data, which are subject to collation. If these data match, with respect to the detail data with data ID “C”, an account title code and imposed department code of the master data are assigned to the debtor, while an accounts payable account title code is assigned to the creditor. In addition, with respect to the detail data with a data ID “D”, a consumption tax account title code is assigned to the debtor, while an accounts payable account title code is assigned to the creditor (step 403, 404).

On the other hand, if collated data does not match, then with respect to the detail data with data ID “C”, an account title code for saving an error code and an imposed department code are assigned to the debtor, while an accounts payable account title code is assigned to the creditor. In addition, with respect to the detail data with a data ID “D”, a consumption tax account title code is assigned to the debtor, while an accounts payable account title code is assigned to the creditor (step 403, 405).

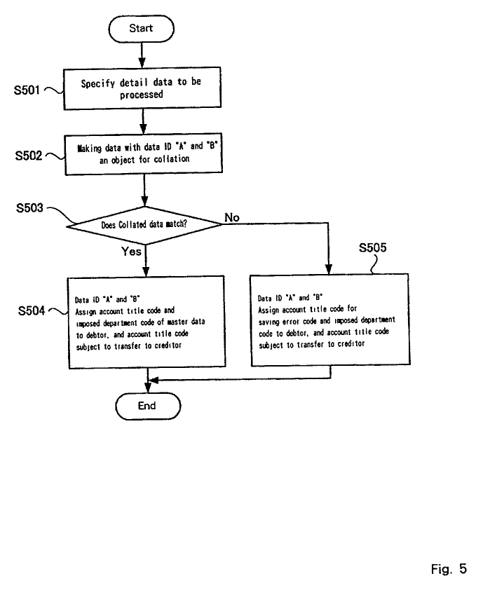

FIG. 5 is a diagram showing an example of an operation for creating transfer journal data by the data collation and journalizing section 50. Referring to FIG. 5, first, detail data that is to be processed is specified using a correspondent code or the like (step 501). Then, specifying a kind of detail data necessary for creating the transfer journal data by using a data ID, and making it an object for collation (step 502). In this operation, journal data is created that is used for transfer within an organization, thus the object of collation is an amount for each transfer key, which correspond to data with data ID “A” and “B” in the example shown in FIG. 2. On the other hand, in master data, an object of collation is master data of a master type that is to be used for creating the transfer journal data. Then, a ledger code, a correspondent code, a transfer key (collation key), and a data ID are collated between the detail data and the master data, which are subject to collation.

If these data match, with respect to the detail data with data ID “A” and “B”, an account title code and imposed department code of the master data are assigned to the debtor, while an account title code subject to transfer is assigned to the creditor (step 503, 504). On the other hand, if collated data does not match, then with respect to the detail data with data ID “A” and “B”, an account title code for saving an error code and an imposed department code are assigned to the debtor, while an account title code subject to transfer is assigned to the creditor (step 503, 505).

The appropriation database 60 is implemented by a storage device such as a magnetic disk drive and a semiconductor memory, which stores appropriation journal data that was created according to the operation shown in FIG. 4 in the data collation and journalizing section 50. The transfer journal database 70 is implemented by a storage device such as a magnetic disk drive and a semiconductor memory, which stores transfer journal data that was created according to the operation shown in FIG. 5 in the data collation and journalizing section 50.

The appropriation journal data stored in the appropriation database 60 is used in a payment procedure of rates as payment data, and stored in the cash book database 130. Also, it is stored in the general ledger database 140 along with the transfer journal data stored in the transfer journal database 70. As a result, the processing for accounting and fund management is performed using each data stored in the cash book database 130 and general ledger database 140.

In an embodiment of the present invention, it is the most common case to perform the aforementioned processing of FIG. 4 and FIG. 5 sequentially to create both appropriation journal data and transfer journal data. However, these two kinds of journal data may not be necessary depending on a form of accounting and fund management or a form of payment at installation of the system or in an organization. Also, either one of these data may be necessary when using the present invention in combination with any other accounting system or the like. For example, when appropriating or writing off expenditures using any other system and transferring the expenditures to each department, only the transfer journal data is necessary. That is, it is effective to perform either operation shown in FIG. 4 or FIG. 5, thereby creating either appropriation journal data or transfer journal data.

Moreover, in the example embodiment of the present invention, classifying detail data on the basis of a predetermined criterion and managing it by adding a data ID, a desired data can become an object of data collation by preparing any algorithm (logic), thereby creating any journal data. For example, selecting data with data ID “A” and data with data ID “D” as an object of data collation to create journal data, journal data of only taxable rates is created.

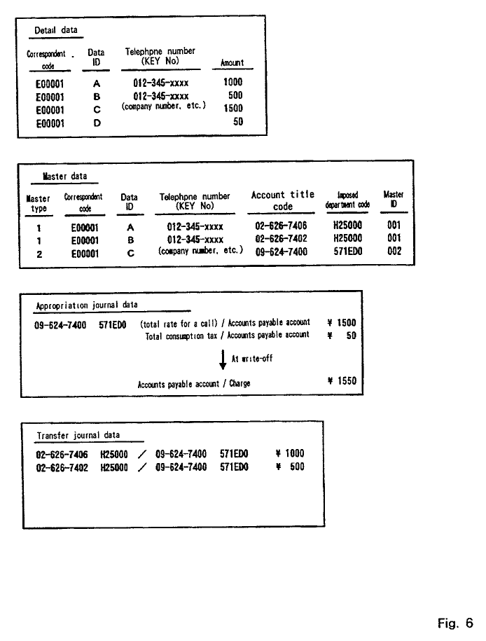

FIG. 6 is a diagram showing appropriation journal data and transfer journal data generated from the detail data 610 converted to a unified format and master data. In this example, there is shown the processing for the automatic transfer service for the rate for a call that occurs relating to a telephone whose phone number (i.e., transfer key, collation key) is “012-345-xxxx”.

Referring to the detail data 610, a correspondent is a telephone company whose correspondent code is “E00001”, wherein the taxable rate for a call (i.e., data ID “A”) is 1000 yen, the nontaxable rate for a call (i.e., data ID “B”) is 500 yen, the total rate for a call (i.e., data ID “C”) is 1500 yen (=1000 yen+500 yen), and the amount of consumption tax (i.e., data ID “D”) is 50 yen (=1000 yen×(5/100)).

Next, referring to the master data 620, it is shown that a master type for creating the transfer journal data is defined as “master type 1”, a master type for creating appropriation journal data is defined as “master type 2”, and further with respect to the taxable rate for a call (i.e., data ID “A”) of the master type 1, the account title code is “02-626-7406”, an imposed department code is “H25000”, while with respect to the nontaxable rate for a call (i.e., data ID “B”) of the master type 1, the account title code is “02-626-7402”, an imposed department code is “H25000”, further with respect to the total rate for a call (i.e., data ID “C”) of the master type 2, the account title code is “09-624-7400”, an imposed department code is “571ED0”.

In creating the appropriation journal data 630, data with data ID “C” and “D” in the detail data, and data of the master type 2 in the master data are used. In journalizing of debtor and creditor, an account title code and imposed department code of the master data are assigned to the debtor, while an accounts payable account title code is assigned to the creditor, with respect to data with data ID “C”, as is shown in FIG. 4 at step 404. In addition, with respect to the detail data with a data ID “D”, a consumption tax account title code is assigned to the debtor, while an accounts payable account title code is assigned to the creditor. Therefore, referring to the appropriation journal data shown in FIG. 6, the following data is created:

09-626-7400 571ED0 (total rate for a call)/accounts payable account 1500 yen

total consumption tax/accounts payable account 50 yen

On the other hand, at the write-off, resulting in the following:

accounts payable account/charge 1550 yen (=1500 yen+50 yen)

Next, in creating the transfer journal data 640, data with data ID “A” and “B” in the detail data, and data of the master type 2 in the master data are used. In journalizing of debtor and creditor, an account title code and imposed department code of the master data are assigned to the debtor, while an account title code subject to transfer is assigned to the creditor, as is shown in FIG. 5 at step 504. Therefore, referring to the transfer journal data shown in FIG. 6, the following data is created:

02-626-7406 H25000/09-624-7400 571ED0 (total rate for a call) 1000 yen

02-626-7402 H25000/09-624-7400 571ED0 (total rate for a call) 500 yen

In this way, creating the appropriation journal data 630 and transfer journal data 640 according to the present invention, all journalizing becomes possible, including appropriation and write-off of expenditures, and transfer between departments in an organization.

### Advantages of the Invention

As mentioned above, according to the present invention, there is provided an expenditure management system for performing the handling of consumption tax exactly. Moreover, there is provided an expenditure management system for performing various kinds of management by creating master data for appropriation and write-off of expenditures and master data for transfer within an organization.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after either or both of the following conversion to another language, code or notation, and/or reproduction in a different material form.

Thus the invention includes an article of manufacture comprising a computer usable medium having computer readable program code means embodied therein for causing a function described above. The computer readable program code means in the article of manufacture comprising computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. An expenditure management system for managing expenditure for an automatic transfer service of rates, comprising:
a detail data input section for inputting detail data about said rates;
a pre-journalizing details database for storing said detail data input at said detail data input section;
a master database for storing master data used for journalizing on the basis of collation with said detail data;
a data collation and journalizing section for collating said detail data stored in said pre-journalizing details database with said master data stored in said master database and creating journal data; and
a journal database for storing said journal data created at said data collation and journalizing section,
wherein said data collation and journalizing section creates multiple kinds of journal data according to the contents of processing for the expenditure management, while said master database stores multiple kinds of master data depending on said multiple kinds of journal data created by said data collation and journalizing section.

2. The expenditure management system according to claim 1, further comprising a data format conversion section that converts the detail data input at said detail data input section into a unified data format, wherein said pre-journalizing details database stores the detail data converted in said data format conversion section.

3. The expenditure management system according to claim 2, wherein said data format conversion section converts the detail data input at said detail data input section into a data format that includes at least a transfer key, an amount for each transfer key, and identification data showing a kind of data that was classified according to journalizing by said data collation and journalizing section.

4. The expenditure management system according to claim 1, wherein said master database storing:
a first master data that manages a total amount of main body that does not include consumption tax within the rates in said detail data, which is used for appropriation and write-off of expenditures as processing in the expenditure management; and
a second master data that manages an amount for each transfer key in said detail data, which is used for transfer as processing in the expenditure management.

5. An expenditure management system for managing expenditure for an automatic transfer service of rates, comprising:
detail data storing means for storing detail data about rates; and
journalizing means for journalizing said detail data,
wherein said detail data storing means classifies said detail data into data for each transfer key, data about a total amount of main body that does not include consumption tax, and data about total consumption tax and storing,
wherein said journalizing means collates master data prepared for collation with said detail data according to the contents of journalizing with data necessary for the journalizing within said detail data and performs journalizing.

6. The expenditure management system according to claim 5, said detail data storing means further classifies data for each said transfer key in said detail data into an amount subject to consumption tax and a nontaxable amount.

7. The expenditure management system according to claim 5, wherein said journalizing means collates data about said total amount of main body stored in said detail data storing means and data about said consumption tax with master data corresponding to data about said total amount of main body, thereby journalizing for appropriation and write-off of expenditures.

8. The expenditure management system according to claim 5, wherein said journalizing means collates data for each said transfer key stored in said detail data storing means with master data corresponding to data for said transfer key, thereby journalizing for transfer.

9. A method for managing expenditure for an automatic transfer service of rates, comprising the steps of:
acquiring detail data about said rates;
creating a plurality of master data according to contents of journalizing, wherein the master data is used for journalizing on the basis of collation with said detail data; and
collating said detail data with said master data and creating multiple kinds of journal data according to contents of processing in the expenditure management.

10. The method according to claim 9, further comprising:
after the step of acquiring detail data, the step of converting the acquired detail data into a unified data format.

11. The method according to claim 9, further comprising: after the step of acquiring detail data, the step of classifying the acquired detail data into data for each transfer key, data about a total amount of main body that does not include consumption tax, and data about total consumption tax.

12. The method according to claim 11, wherein the step of classifying the detail data further comprising the step of multiplying a total amount of main body subject to consumption tax within data for each transfer key in said detail data by a value corresponding to a consumption tax rate to calculate an amount of consumption tax for the data about total consumption tax.

13. The method according to claim 9, wherein the step of creating master data further comprises the steps of:
creating a first master data that manages a total amount of main body that does not include consumption tax within the rates in said detail data; and
creating a second master data that manages an amount for each transfer key in said detail data, and
wherein the step of creating journal data further comprises the steps of:
collating said detail data with said first master data to create journal data for appropriation and write-off of expenditures; and
collating said detail data with said second master data to create journal data for transfer.

14. A recording medium storing a program readable by input means of a computer and causing the computer to execute the processing, the processing comprising:
processing for acquiring detail data about rates;
processing for acquiring a plurality of master data prepared according to contents of journalizing, wherein the master data is used for journalizing on the basis of collation with said detail data; and
processing for collating said detail data with said master data and creating multiple kinds of journal data according to contents of processing in the expenditure management.

15. The recording medium according to claim 14, the processing further comprising:
after the processing for acquiring detail data, processing for converting the acquired detail data into a unified data format.

16. The recording medium according to claim 14, the processing further comprising:
after the processing for acquiring detail data, processing for classifying the acquired detail data into data for each transfer key, data about a total amount of main body that does not include consumption tax, and data about total consumption tax.

17. A computer program product comprising a computer usable medium having computer readable program code means embodied therein for causing the expenditure management system for managing expenditure for an automatic transfer service of rates, the computer readable program code means in said computer program product comprising computer readable program code means for causing a computer to effect the functions of claim 1.

18. A computer program product comprising a computer usable medium having computer readable program code means embodied therein for causing the expenditure management system for managing expenditure for an automatic transfer service of rates, the computer readable program code means in said computer program product comprising computer readable program code means for causing a computer to effect the functions of claim 5.

19. An article of manufacture comprising a computer usable medium having computer readable program code means embodied therein for causing expenditure management for an automatic transfer service of rates, the computer readable program code means in said article of manufacture comprising computer readable program code means for causing a computer to effect the steps of claim 9.

20. A program storage device readable by machine, tangibly embodying a program of instructions executable by the machine to perform method steps for managing expenditure for an automatic transfer service of rates, said method steps comprising the steps of claim 9.
